(19) United States
(12) Patent Application Publication
(10) Pub. No.: US 2026/0087258 A1
(43) Pub. Date: Mar. 26, 2026

(54) SCALING HIGH IMPACT INNOVATION WITH LARGE LANGUAGE MODELS

(71) Applicant: X DEVELOPMENT LLC, Mountain View, VA (US)

(72) Inventors: Christopher Hahn, Palo Alto, CA (US); Julia Black Ling, Menlo Park, CA (US); David Andre, San Francisco, CA (US)

(21) Appl. No.: 19/294,817

(22) Filed: Aug. 8, 2025

Related U.S. Application Data
(60) Provisional application No. 63/698,337, filed on Sep. 24, 2024.

(51) Int. Cl. G06F 40/30; G06F 16/338

(52) U.S. Cl. CPC G06F 40/30; G06F 16/338

(57) ABSTRACT

Aspects of the disclosure relate to identifying potential areas of innovations utilizing machine learning models such as LLMs. As an example, a plurality of application areas and a plurality of sources may be identified. A model may be used to score pairs of each one of the plurality of application areas with respect to each one the plurality of sources. A matrix of the scores may be generated and provided for display to a user.

### CROSS-REFERENCE TO RELATED APPLICATION

The present application claims the benefit of the filing date of U.S. Provisional Application No. 63/698,337, filed Sep. 24, 2024, the entire disclosure of which is incorporated by reference herein.

### BACKGROUND

Identifying potential intersections between today's problems and available technology can be a difficult and time-consuming endeavor. It requires both domain expertise for idea generation and a broad understanding of applicable technologies. This in itself can create greater challenges because of the oftentimes limited interaction between those investigating problems and those doing research and development.

Large language models (LLMs) are machine learning models that are capable of processing different types of input including natural language (text) as input and providing textual outputs. LLMs have proven useful in a wide variety of tasks, including for example, text generation, classification, responding to questions, summarizing large text documents, natural language processing and understanding, semantic and sentiment analysis, code generation, audio analysis, translation, and more.

### BRIEF SUMMARY

Aspects of the disclosure provide a method. The method includes, identifying, by one or more processors, a plurality of application areas; identifying, by the one or more processors, a plurality of sources; using, by the one or more processors, a model to score pairs of each one of the plurality of application areas with respect to each one the plurality of sources; generating, by the one or more processors, a matrix of the scores; and providing, by the one or more processors, the matrix of scores for display to a user.

In one example, the method also includes receiving user input providing the plurality of application areas. In another example, each application area of the plurality of application areas defines a problem. In another example, each source of the plurality of sources is one of a scientific paper or article. In another example, the method also includes conducting a search in order to identify at least one of the plurality of sources based on at least one of the plurality of application areas. In another example, the method also includes receiving user input providing the plurality of sources. In another example, the model is a machine learning model. In addition or alternatively, the model is a large language model. In this example, the large language model is a long context model. In addition or alternatively, the large language model is multimodal.

In another example, the method also includes providing information identifying the plurality of sources and the plurality of application areas for display with the matrix to enable the user to relate the scores to individual ones of the pairs. In another example, the matrix is generated such that different entries of the matrix with different scores are provided with different visual treatments to differentiate the different scores. In another example, the method also includes providing a prompt to the model, wherein the prompt provides instructions to the model that for a given pair of one of the plurality of application areas and one of the plurality of sources to provide a summary of the source, ideas for how the source could be applied to that application area, and the score for the given pair. In another example, the method also includes receiving user input identifying a selection of an entry in the matrix, and, in response to receiving the user input, providing results of the model for display to the user. In this example, the entry is associated with an application area and source pair and the results include a model-generated summary of a source and ideas for how the source could be applied to an application area. In addition or alternatively, the results are provided with an option for the user to chat with the model about the results. In addition, the method also includes receiving user input selecting the option; and, in response to the user input, providing a chat interface to enable the user to engage in a conversation with the model about the results. In another example, the method also includes providing a prompt to the model, wherein the prompt defines a rubric for determining the scores based on at least a novelty subscore and a relevance subscore for a given pair. In another example, the method also includes, receiving user input identifying a metric and a rubric for evaluating that metric, wherein the scores are determined further based on the received user input. In another example, the method also includes receiving at least one additional application area or source; in response to receiving the at least one additional application area or source, updating the matrix with one or more additional scores; and providing the updated matrix for display to the user.

In another example, the method may also include, generating, by the one or more processors, an experiment for at least one of the pairs; and in response to a user selecting the experiment, running, by the one or more processors, the experiment. In addition, generating the experiment is based on the matrix of scores. In addition or alternatively, the method also includes updating the matrix of scores based on results of running the experiment.

A further aspect of the disclosure provides a system comprising one or more processors. The one or more processors are configured to identify a plurality of application areas; identify a plurality of sources; use a model to score pairs of each one of the plurality of application areas with respect to each one the plurality of sources; generate a matrix of the scores; and provide the matrix of scores for display to a user.

### BRIEF DESCRIPTION OF THE DRAWINGS

FIGS. 1A and 1B depict an example computer architecture in accordance with aspects of the disclosure.

FIG. 2 is an example of an interface for adding application areas in accordance with aspects of the disclosure.

FIG. 3 is an example of an interface for adding sources in accordance with aspects of the disclosure.

FIG. 4 is an example visualization of a process for identifying potential areas of innovation in accordance with aspects of the disclosure.

FIG. 5 is an example of an interface including a matrix in accordance with aspects of the disclosure.

FIG. 6 is an example of an interface including results of a model in accordance with aspects of the disclosure.

FIG. 7 is an example full text of results of a model in accordance with aspects of the disclosure.

FIG. 8 is an example of a chat interface in accordance with aspects of the disclosure.

FIG. 9 is an example flow diagram for identifying potential areas of innovation in accordance with aspects of the disclosure.

### DETAILED DESCRIPTION

### Overview

The features described herein may provide a framework for identifying potential areas of innovation utilizing machine learning models such as LLMs. A user may be provided with the most relevant points of scientific papers, patents, technical reports, articles, blogs or vlogs, user needs, applications, and novel ideas as well as the possibility to chat with a foundational model about some idea, where the model draws inspiration from the complete matrix of sources and applications. In addition, the information is presented in a user-friendly, concise, and straightforward way.

For instance a plurality of application areas may be identified. These application areas may be identified by a user. For example a user may provide a short title for an application area as well as an explanation of the application area represented as a use-case or problem statement.

In addition to the plurality of application areas, a plurality of sources may be identified. These sources may include scientific papers, patents, technical reports, articles, blogs or vlogs, and may be retrieved directly from a repository of such sources. In some instances, searches may be conducted for a source based on any of the plurality of application areas.

A model may be used to score pairs each one of the plurality of application areas with respect to each one the plurality of sources. For instance, the application areas and sources may be input into a model in order to compute a relevance score. This may include submitting a prompt identifying a metric for analysis of application area and source pairs. In other words, each application area and source may be paired and a score determined for that pair. In addition, the prompt may request that the model provide additional information for each application area and source pair. For instance, for a given application area and source pair, the model may be asked to perform a set of tasks.

A matrix of the scores may be generated and provided for display to a user. This matrix may be a representation of the potential relevance of a source to an application area for a set of technologies and a set of applications. The matrix may identify the source on one axis and the application areas on another axis. In some instances, scores may be provided with a visual treatment to differentiate different scores. This may allow a user to quickly and easily identify the most interesting and useful pairs. This may therefore enable a user to find relevant connections across a wide range of technologies and applications areas and to explore those further regardless of the volume of source material.

The matrix may enable a user to investigate the pairs further. For example, by selecting a particular entry in the matrix, the user may be provided with the results of the model's analysis of the application area and source for that pair. This may be displayed, for example, via a popup or by opening a new page or window. For instance, the results may include the summary of the source, the ideas, the subscores, and the score.

The user may also be provided with an option to share the matrix with other users to enable collaboration. In addition, in order to investigate pairs and/or ideas further, a user may select an option to chat with the model. The model may also be provided with an opportunity to retrieve an arbitrary snippet from another source that the user has found interesting to complement the discussion, for example, by taking prompts entered by the user and conducting a RAG search to pull additional information from those sources. By enabling a user to communicate with the model about an idea or pair by asking questions, this may enable further innovation and refinement of the ideas.

The features described herein may provide a framework for identifying potential areas of innovations utilizing machine learning models such as LLMs. As described above, a user may be provided with the most relevant points of scientific papers, patents, technical reports, user needs, applications, and novel ideas as well as the possibility to chat with a foundational model about some idea, where the model draws inspiration from the complete matrix of sources and applications. The features described herein may therefore enable a user to find relevant connections across a wide range of technologies and applications areas and to explore those further regardless of the volume of source material (e.g., 50 sources, 100 sources, or more). This may potentially accelerate the pace of innovation by automating time-consuming tasks and allowing researchers, innovators and entrepreneurs to focus on the creative aspects of their work in a user-friendly, concise, and straightforward way. This, in turn, may increase the number and pace of innovations that address some of the world's most pressing challenges thus potentially providing for greater innovation at scale. Additionally, the features described herein may be used to better organize innovation information, making it accessible to others, potentially ensuring continuity in innovation efforts.

### Example Systems

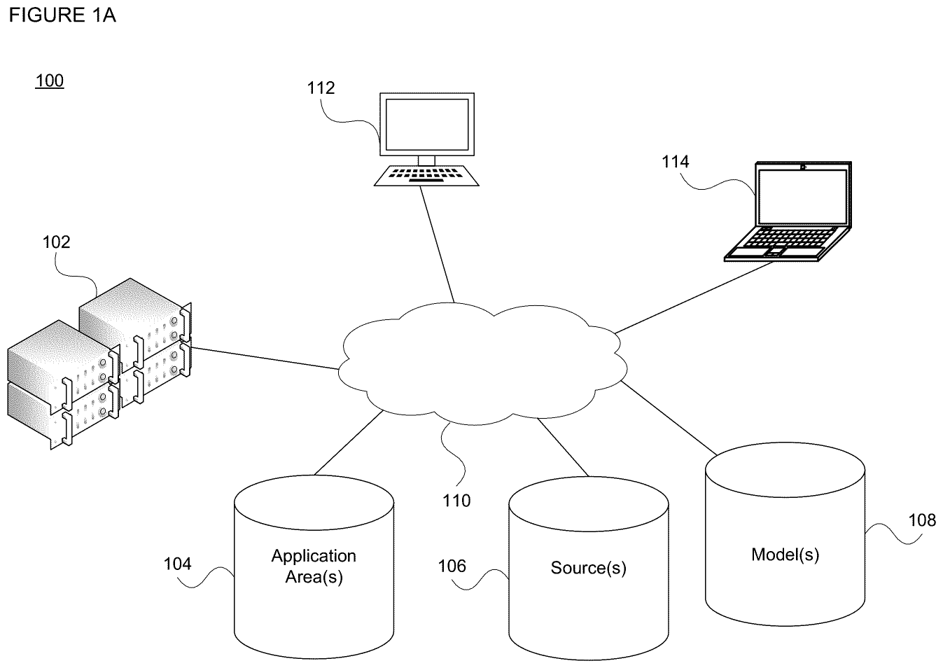

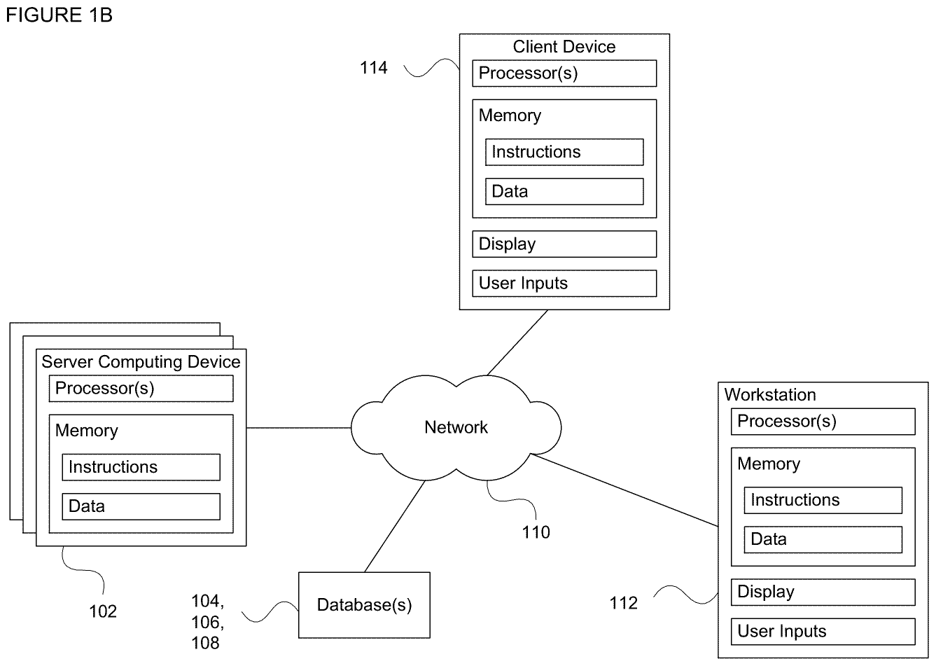

The models described herein may be implemented using one or more tensor processing units (TPUs), GPUs, CPUs or other computing in accordance with the features disclosed herein. One example of a computing architecture is shown in FIG. 1A and FIG. 1B. In particular, FIG. 1A and FIG. 1B are pictorial and functional diagrams, respectively, of an example system 100 that includes a plurality of computing devices and databases connected via a network. For instance, one or more computing devices 102 may be implemented as a cloud-based server system. Databases 104, 106, 108 may store various information including, for example, application areas, sources, various models as well as associated data. While three databases are shown, such information may be stored in one or more databases that maintain different types of information. A server system, such as one or more computing devices 102, may access the databases via network 110 and exchange information with the various other devices of the system including client devices. For instance, as discussed further below, the computing devices 102 may use network 110 to transmit and present information to a user on a display of a client computing device. As an example, such client devices may include one or more of a desktop computer (e.g., computing device 112) (e.g., a workstation) and a laptop or tablet PC (e.g., computing device 114), although other types of client devices may be employed.

As shown in FIG. 1B, each of the computing devices 102 and 112-114 may include one or more processors, memory, data and instructions. The memory stores information accessible by the one or more processors, including instructions and data (e.g., LLM models and corpuses of input data) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, graphic processing units (GPUs), etc. Alternatively, each processor may be a dedicated device such as an ASIC or other hardware-based processor. Although FIG. 1B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of one or more computing devices 102. Accordingly, references to a processor or computing device will be understood to include references to a collection of processors or computing devices or memories that may or may not operate in parallel.

Reference to “one or more processors” herein includes situations where a set of processors (e.g., two or more CPUs, TPUs, GPUs or any combination thereof) may be configured to perform one or more operations. Any combination of such a set of processors may perform individual operations or a group of operations. Therefore, reference to “one or more processors” does not require that all processors in the set must perform all of the operations. Rather, unless expressly stated, any one of the one or more processors may perform different operations when a set of operations is indicated. For instance, different processors may perform specific operations. For example, a first processor performs one or more iterations of accessing data set batches of embeddings, while a second processor performs one or more iterations of assigning unique identifiers, while a third processor performs one or more iterations of training a model. For another instance, multiple processors (e.g., multiple GPUs, TPUs, etc.) may each perform the various operations. In this example, each processor (e.g., GPU and/or TPU) performs a portion of accessing dataset batches of embeddings, assigning unique identifiers, and/or training a model in conjunction with the other processors (e.g., in parallel), and those same processors each perform a portion of accessing dataset batches of embeddings, assigning unique identifiers, and/or training a model.

The computing devices may include all of the components normally used in connection with a computing device such as the processor and memory described above as well as a user interface subsystem for receiving audio and/or other input from a user and presenting information to the user (e.g., text, imagery, videos and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users. This enabled the client device to present information to a user, as well as to perform question-answering such as in a domain expert in-context conversation for active learning.

The client computing devices (e.g., 112-114) may communicate with a back-end computing system (e.g., one or more computing devices 102) via one or more networks, such as network 110. The network 110, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 102 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 102 may include one or more server computing devices that are capable of communicating with any of the computing devices 112-114 via the network 110.

The computing device 102 may process data utilizing a machine learning LLM as discussed further below. The model may employ, by way of example, various transformer-type architectures (including encoder-decoder, encoder only, dual encoders, decoder-only, and so on), a convolutional neural network (CNN), recurrent neural network (RNN), long short-term memory (LSTM) network, or combination thereof capable of performing various tasks. These tasks may include, for example, text generation, classification, responding to questions, summarizing large text documents, natural language processing and understanding, semantic and sentiment analysis, code generation, audio and visual analysis, clustering, similarity evaluation, translation, retrieval augmented generation (RAG), and more. In some instances, the LLMs described herein may be long-context and multimodal. That is, the LLM may be capable of processing different types of modalities (e.g., images, video, audio, text and coding) and providing appropriate responses, such as the Gemini models provided by GOOGLE LLC. Other commercially available machine learning models and LLMs may also be used.

### Example Methods

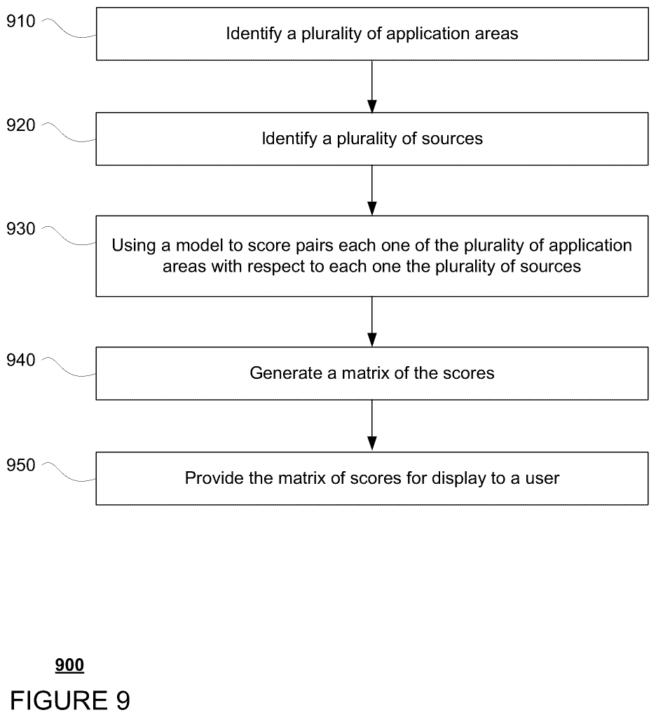

As noted above, the computing devices 102 may enable users to identify potential areas of innovations utilizing machine learning models such as LLMs. FIG. 9 depicts an example flow diagram of a method 900 for generating and displaying a matrix of scores for pairs of sources and application areas for a “brainstorm”. The blocks in this flow diagram may, for example, be performed by one or more processors of the computing device 102. Depending upon the model use, all or some of these blocks may be performed by processors at different computing devices, such as locally at computing device 112 and/or computing device 114. While FIG. 9 shows blocks in a particular order, the order may be varied and multiple operations may be performed simultaneously. Also, operations may be added or omitted.

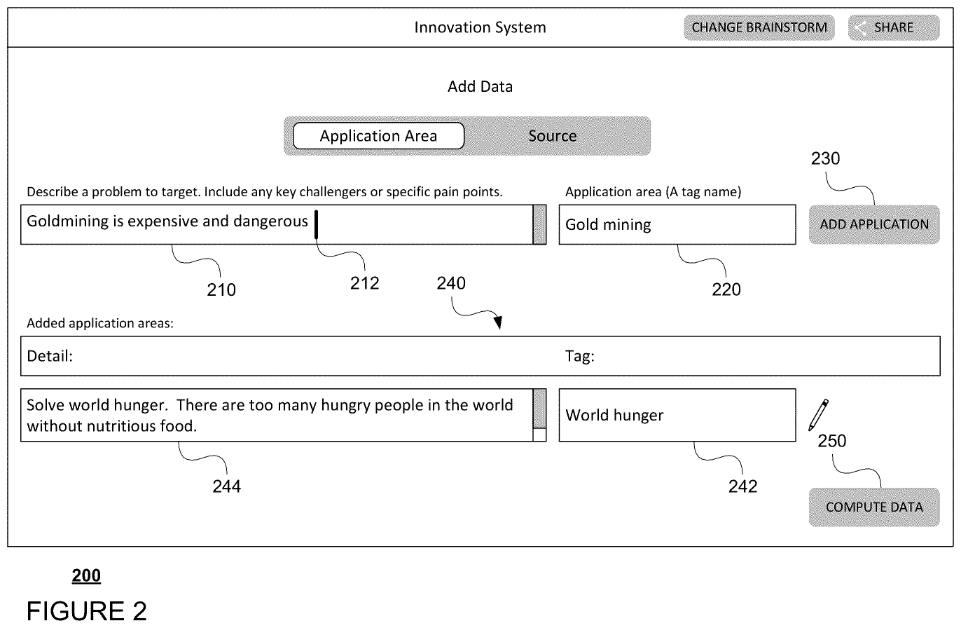

At block 910, a plurality of application areas is identified. These application areas may be identified by a user. For example a user may provide a short title for an application area as well as an explanation of the application area represented as a use-case or problem statement. FIG. 2 is an example of an interface 200 for adding application areas which may be displayed to a user (e.g., a human operator) on a client computing device, such as computing device 112, 114. In this example, interface 200 includes fields 210, 220 for entering information for a new application area including field 210 for entering text for describing or defining a use case or problem to target and field 220 for entering text for a tag for the new application area. As an example, the user has entered “Gold mining” in field 230 as a new application area and as indicated by cursor 212, is in the process of entering the description for the new application area.

Once satisfied with the information entered in the fields, the user may select an option, such as option 230, in order to add the new application area. Interface 200 also includes information 240 identifying details (including details and tags) for previously added application areas. For example, the interface 200 includes details 242, 244 for an application area of “World hunger” with a use case or problem to target defined as “Solve world hunger. There are too many hungry people in the world without nutritious food.” Once the user is satisfied with all new application areas entered in the interface 200, the user may select option 250 to compute data and generate a matrix as discussed further below.

Returning to FIG. 9, at block 920, a plurality of sources is identified. These sources may include scientific papers, patents, technical reports, articles, blogs or vlogs, and may be retrieved directly from a repository of such sources. In some instances, the computing device 102 may conduct searches for a source (e.g., a search of a particular repository such as a library or online database, perform a web crawl, etc.) based on any of the plurality of application areas. In some instances, the system may engage in continuous sources, sending alerts and creating additional ideas when new sources relevant to an application area are identified. In some instances, a user may select an option in an interface to include an additional source of interest.

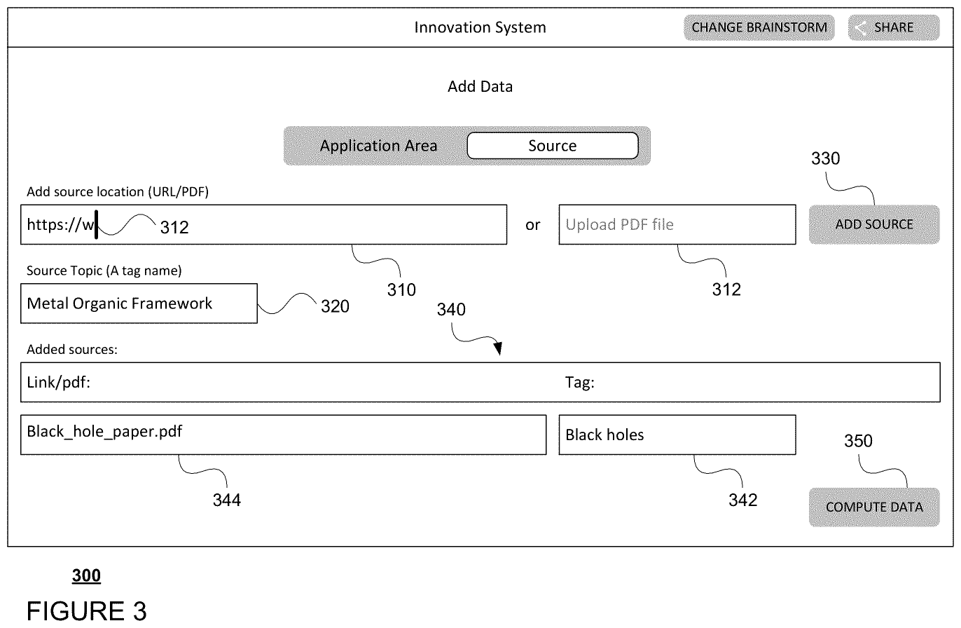

FIG. 3 is an example of an interface 300 for adding sources which may be displayed to a user on a client computing device, such as computing device 112, 114. In this example, interface 300 includes fields 310, 312, 320 for entering information for a new source. In this example, field 310 enables the user to input a uniform resource locator (URL) while field 312 allows the user to upload a file including the source (e.g., a PDF file). Field 320 enables the user to enter a tag for the new source. As an example, the user has entered “Metal Organic Framework” in field 220 as a tag for a new source and as indicated by cursor 212, is in the process of entering a URL for the new source.

Once satisfied with the information entered in the fields, the user may select an option, such as option 330, in order to add the new source. Interface 200 also includes information 240 identifying details (including details and tags) for previously added application areas. For example, the interface 200 includes details 340, for a source with a tag 342 of “Black holes” and including a file name 344 of “Black_hole_paper.pdf”. Once the user is satisfied with all new application areas entered in the interface 200, the user may select option 350 to compute data and generate a matrix as discussed further below.

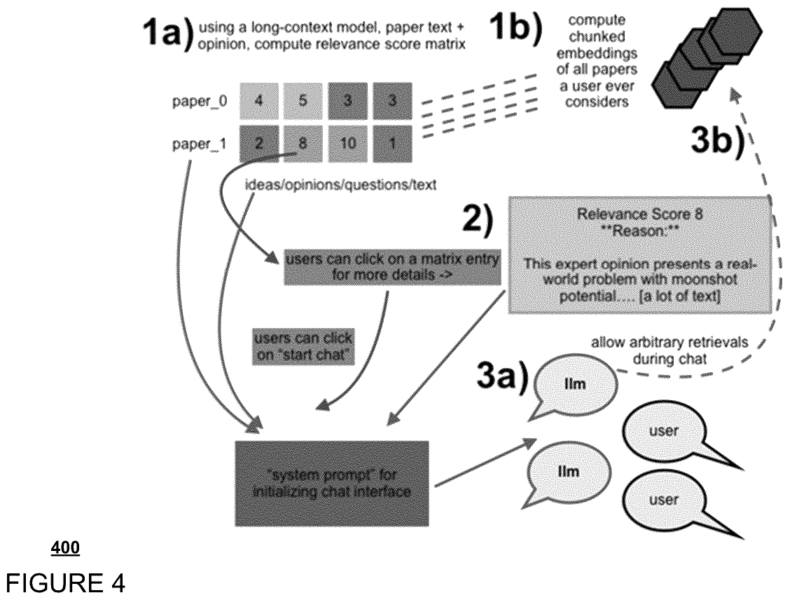

Returning to FIG. 9, at block 930, a model is used to score pairs each one of the plurality of application areas with respect to each one the plurality of sources. For instance, the application areas and sources may be input into a model by the computing device 102 in order to compute a relevance score. FIG. 4 is an example visualization 400 of a process for identifying potential areas of innovation. In this example, as represented at 1a), user-provided application areas and any sources may be input into a long-context LLM in order to compute a relevance score. This may include submitting a prompt identifying a metric for analysis of application area and source pairs. In other words, each application area and source may be paired and a score determined for that pair.

In addition, the prompt may request that the model provide additional information for each application area and source pair. For instance, for a given application area and source pair, the model may be asked to perform a set of tasks. These tasks may include 1) summarizing that source (e.g., provide a summary of the main technology described in the source), 2) providing a list of ideas for how the source could be applied to that application area, and 3) providing a score for the ideas. As an example, the score may relate to the relevance and novelty of the ideas. For example, ideas that are already in widespread use would have low novelty, whereas ideas that represent significant departures from prior research directions have high novelty. As an example, ideas that are more closely related or connected to the source and application area may have a greater relevance score than those that are less related or connected. The prompt itself may therefore provide instructions that enable the model to both elaborate and to be creative.

The following is an example prompt p which may be input into a long-context LLM: You are an entrepreneur trying to find creative new solutions for a set of challenging applications.

You have three tasks:
1) First, summarize the key innovations described in the emerging technology paper.
2) Second, find creative ideas for applying the emerging technology described in the paper to the challenging application described below. These ideas should be original, creative, and out-of-the-box.
3) Third, provide a single total score on a scale of 0 to 10 for the moonshot potential of those ideas for this challenging application. This score should be the sum of two subscores: a score for novelty of the ideas on a scale of 0 to 5 and a subscore on relevancy of the paper to the ideas on a scale of 0 to 5. Use the following rubric:

### Novelty (0-5):

*0: The ideas have been implemented or widely discussed in existing literature.
*1-2: The ideas represent a minor improvement or adaptation of existing approaches. It might offer some benefits but lacks significant originality.
*3-4: The ideas introduce a novel concept or a creative combination of existing technologies. It demonstrates originality and potential for impact.
*5: The ideas are truly groundbreaking and disruptive, representing a paradigm shift in the field. It has the potential to revolutionize the way we approach the challenge.

### Relevance (0-5):

*0: The technology has no clear connection to the challenge and is unlikely to be applicable even with extensive modifications.
*1-2: The technology might be applicable with significant modifications or adaptations. Its relevance to the challenge is limited.
*3-4: The technology can be adapted to address the challenge with moderate effort. It shows promise but might require some adjustments to fully realize its potential.
*5: The technology is a perfect fit for the challenge, requiring minimal or no adaptation. It has the potential to directly and significantly impact the challenge.

It is expected that most overall scores will be low (0-2) because most technologies have been applied before to the applications to which they are most relevant. Only the most exciting, novel, and relevant combinations of emerging technology and application should receive overall scores above 7.

```
  Now it's your turn.
  *Emerging Technology Paper*: ‘’‘’‘’ [insert paper content here]
  + “\n *Challenging Application*: ” [Insert application content here] + “*Please respond
in the following format, where the Total Score is a single number between 0 and 10*: \n Paper
Summary: \nIdeas:\nTotal Score (single number between 0 and 10):\nNovelty and Relevance
Subscores and Reasoning (not divided per idea, single combined novelty and single relevance
score across ideas):”
  )
```

In this example, the system may cause the model to iterate through the prompt with different application areas (e.g., “application_area_text”) and source (e.g., “source_text”) pairs in order to perform the aforementioned 3 tasks for each of the pairs. The prompt includes instructions for how the model is to summarize each source (e.g., “summarize the key innovations described in the emerging technology paper”), how the model is to provide a list of ideas (e.g., “find creative ideas for applying the emerging technology described in the paper to the challenging application described below. These ideas should be original, creative, and out-of-the-box.”), and a rubric or weights how the model is to provide a score (e.g., provide a single total score on a scale of 0 to 10 for the moonshot potential of those ideas for this challenging application. This score may be the sum of two subscores: a score for novelty of the ideas on a scale of 0 to 5 and a subscore on relevancy of the paper to the ideas on a scale of 0 to 5.”). For the scores, the prompt also provides a rubric defining how the model should evaluate novelty subscores (e.g., “Novelty (0-5): . . . ”), relevance subscores (e.g., “Relevance (0-5): . . . ”), and the scores based on those subscores. In this example, additional specifics defining the scores are also provided (e.g., “It is expected that most overall scores will be low (0-2) because most technologies have been applied before to the applications to which they are most relevant. Only the most exciting, novel, and relevant combinations of emerging technology and application should receive overall scores above 7.”) Although the prompt provided herein provides specific instructions, rubrics, and specifics on scoring, these may be adjusted depending upon the needs of the system and users of the system. For example, the scores and/or subscores may be based on other metrics such as economic viability, technical feasibility, and product differentiation.

In some instances, the prompt may be editable by the user. For instance, the user may specify any metric and/or rubric for evaluating that metric. As an example, this information may be input via a text interface, which may be similar to the examples of FIG. 2 or 3 described above. In some instances, the user may specify relative weights, for example, by entering specific values and/or via adjusting sliders or other similar features, between the various metrics specified. Alternatively, the user may be provided with a list of predefined metrics and the user can select which metrics to use along with a rubric (e.g., relative weights). Thus, the computing devices 102 or another computing device may receive user input via an interface providing information identifying a metric and/or rubric for evaluating that metric and may generate the prompt accordingly. As a result, the aforementioned scores and/or subscores may be determined based on this generated prompt based on the user input.

The relevance subscore may also be generated using retrieval augmented generation (RAG), by searching for the most relevant chunks of a source through vector search of the source's embeddings and evaluating the similarity scores between the idea, the source, and the description of the application area.

Returning to FIG. 9, at block 940, a matrix of the scores is generated. At block 950, the matrix may be provided for display to a user. For instance, the computing device 102 may take the results of the model and generate a matrix. This matrix may be a representation of the potential relevance of a source (and the technology described in that source) to an application area for a set of technologies and a set of applications. The matrix may identify the source on one axis and the application areas on another axis. In some instances, scores may be provided with a visual treatment to differentiate different scores. As an example, entries in the matrix may be color coded on a particular scale to indicate higher or lower scores. In this regard, lighter shades or colors may indicate lower scores and darker shades or colors may indicate higher scores (or vice versa). This may allow a user to quickly and easily identify the most interesting and useful pairs. This may therefore enable a user to find relevant connections across a wide range of technologies and applications areas and to explore those further regardless of the volume of source material (e.g., 50 sources, 100 sources, or more).

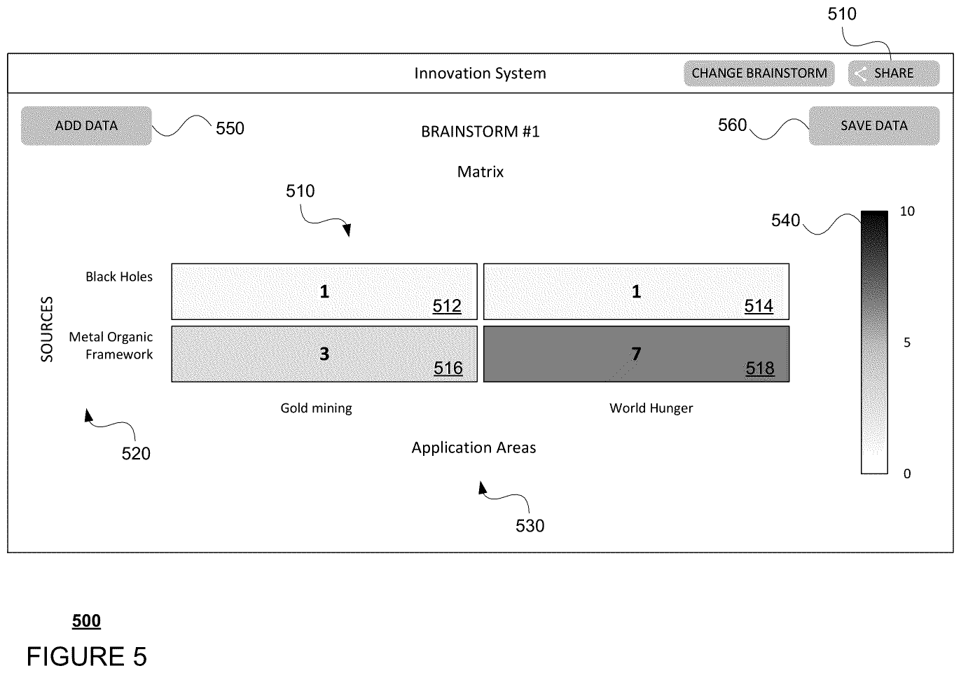

The matrix may then be provided for display to a user, for example, by sending the matrix and related information to a client computing device, such as computing device 112, 114. FIG. 5 is an example of an interface 500 including a matrix 510 for a brainstorm, here identified as “BRAINSTORM #1” (which may simply be a title for an innovation session selected or provided by a user). As an example, interface 500 may be displayed on a client computing device, such as computing device 112, 114. In this example, matrix 510 relates sources 520 (including those with the Black holes and Metal Organic Framework) and application areas 530 (including Gold mining and World hunger). In this example, each entry 512, 514, 516, 518 includes a numerical value corresponding to the score of a pair of one application area with one source. In this example, for representation purposes only, the score for the pair of “World hunger” and “Metal Organic Framework” is 7, while the score for the pair of “Black holes” and “World hunger” is 1. In addition, the entries in the matrix are shaded to represent the value of each entry according to the scale 540, here of 0 to 10. In this example, darker entries (such as entry 518) represent higher scores, while lighter entries (such as entries 512, 514) represent lower scores. Of course, as noted above, different scales, shading and colors may be used to represent different scores.

The interface 500 also includes an option 550 to allow a user to add additional application areas and/or sources. In this regard, if selected, the user may be provided with interfaces similar to those of interface 200 or interface 300. Each time a user adds an additional application area and/or source and selects to compute new data (e.g., selects the option 250 or option 350), the computing devices 102 may resubmit the prompt to the model. As a result, additional summaries, ideas and scores may be determined for the new application area (or source) paired with any prior sources (or prior application areas) and a new matrix generated and displayed to the user.

The interface 500 also includes an option 560 which may allow the user to save the matrix and related information for the brainstorm for later use.

The matrix may enable a user to investigate the pairs further. For example, by selecting a particular entry in the matrix, the user may be provided with the results of the model's analysis of the application area and source for that pair as represented in FIG. 4 at 2). This may be displayed, for example, via a popup or by opening a new page or window. For instance, the results may include the summary of the source, the ideas, the subscores, and the score.

Referring to the prompt p above, the prompt may also provide instructions for how the results are to be displayed when selected by the user (e.g., “*Please respond in the following format, where the Total Score is a single number between 0 and 10*: \n Paper Summary: \nIdeas:\nTotal Score (single number between 0 and 10):\nNovelty and Relevance Subscores and Reasoning (not divided per idea, single combined novelty and single relevance score across ideas):”). Although the prompt provided herein provides specific instructions for providing the results, these may be adjusted depending upon the needs of the system and users of the system.

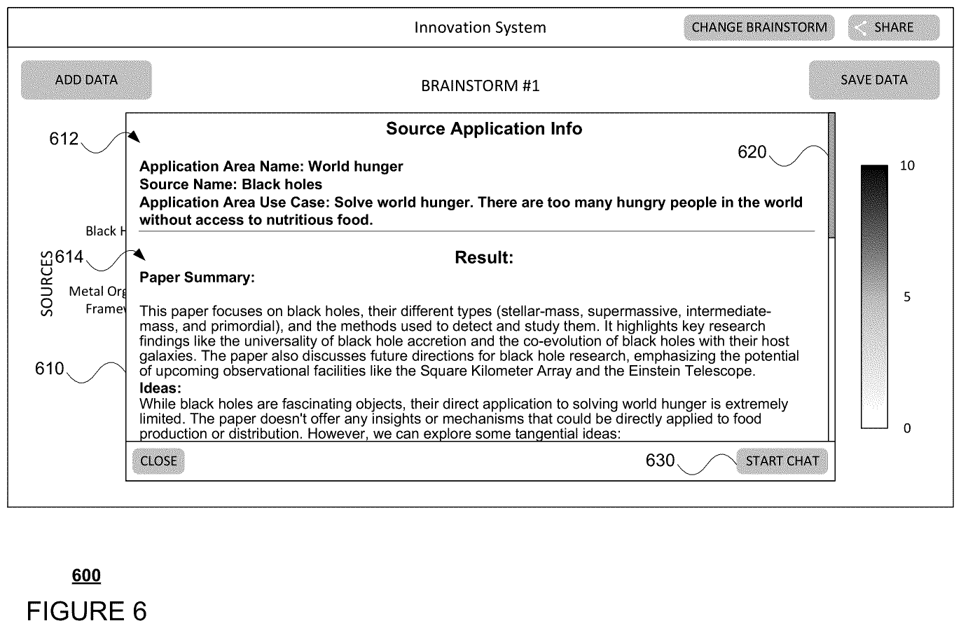

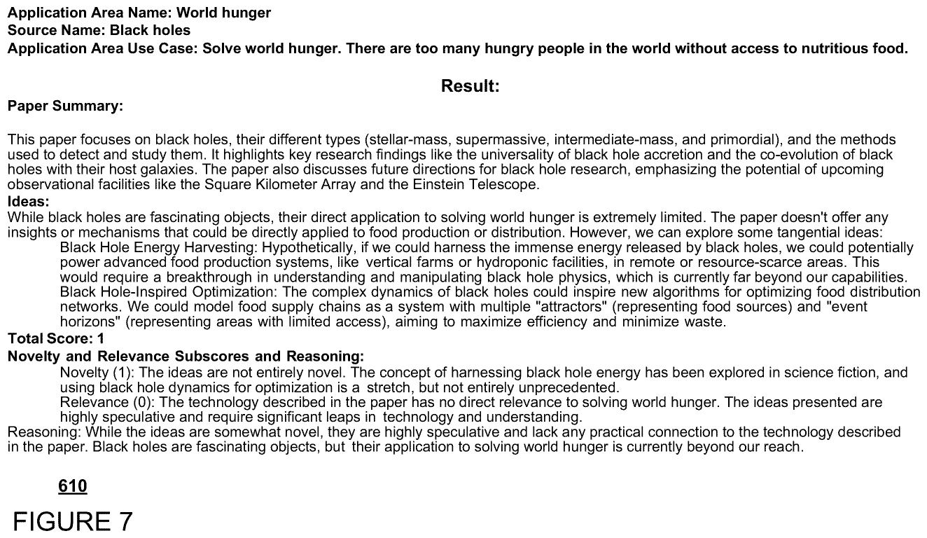

FIG. 6 is an example of an interface 600 including an example of results 610. As an example, interface 600 may be displayed on a client computing device, such as computing device 112, 114. In this example, the user may have selected entry 514 corresponding to the “Black hole” and “World hunger” pair. The results 610 are depicted as a popup window overlaid onto the interface 500, but as noted above, may be displayed in various ways. Here, given the quantity of text provided, a slider bar 620 may be used to allow the user to scroll through the text. For ease of representation, FIG. 7 is an example of the full text of the results 610.

In order to better aid the user, the results 610 also include information 612 about the application area and source pair including the tags (“Application Area Name” and “Source Name”) as well as the use case or problem to target (“Application Area Use Case”) for the “Black hole” and “World hunger” pair. Below this information, is additional information 614 about the results including the summary (“This paper focuses on black holes, their different types (stellar-mass, supermassive, intermediate-mass, and primordial), and the methods used to detect and study them. It highlights key research findings like the universality of black hole accretion and the co-evolution of black holes with their host galaxies. The paper also discusses future directions for black hole research, emphasizing the potential of upcoming observational facilities like the Square Kilometer Array and the Einstein Telescope.”

As shown in FIG. 7, the results 610 also include a list of ideas including “Black Hole Energy Harvesting: Hypothetically, if we could harness the immense energy released by black holes, we could potentially power advanced food production systems, like vertical farms or hydroponic facilities, in remote or resource-scarce areas. This would require a breakthrough in understanding and manipulating black hole physics, which is currently far beyond our capabilities.” and “Black Hole-Inspired Optimization: The complex dynamics of black holes could inspire new algorithms for optimizing food distribution networks. We could model food supply chains as a system with multiple ‘attractors’ (representing food sources) and “event horizons” (representing areas with limited access), aiming to maximize efficiency and minimize waste.”

The results 610 also include details about the score (“Total Score: 1”) as well as the subscores. In this example, the novelty subscore is 1 based on the model's determination that “The ideas are not entirely novel. The concept of harnessing black hole energy has been explored in science fiction, and using black hole dynamics for optimization is a stretch, but not entirely unprecedented.” In addition, the relevance subscore is 0 based on the model's determination that “The technology described in the paper has no direct relevance to solving world hunger. The ideas presented are highly speculative and require significant leaps in technology and understanding.” The results 610 also include additional information about the reasoning behind the scores “While the ideas are somewhat novel, they are highly speculative and lack any practical connection to the technology described in the paper. Black holes are fascinating objects, but their application to solving world hunger is currently beyond our reach.”

In some instances the prompt may require that the model perform a loop until only ideas that result in minimum subscores and/or minimum scores are met. For example, a prompt may require that the model only include ideas which result in a score of at least 6 and/or a novelty score of at least 3. As another example, a prompt may require that the model only include ideas which result in a score of at least 7 and/or a relevance score of at least 5. In some instances, the model may sample ideas until they meet such a threshold as well as a set of constraints/criteria specified by the user. For example, a user may want to avoid certain types of ideas (e.g. no ideas related to topic X). In some instances, the computing devices may have the model iteratively search if the idea did not have a high enough score or particular subscore, if no such ideas are found, a notification may be displayed to the user, for instance on a client computing device, such as computing device 112, 114, indicating that an idea failed to meet the minimum subscores and/or minimum scores are met.

In addition to the aforementioned results, the prompt may also be used to propose experiments. For example, the prompt may include text to request that the model generate initial experiments for validation of an application area and source pair in the matrix or rather for the ideas for how that source could be applied to that application area. The following is an example of additional text that could be included with prompt p above and input into the long-context LLM: Given the below resource list, could you please answer whether the idea can be meaningfully prototyped and if so, propose an initial experiment.

### {Insert Resource List}

These experiments may be based on a set of available resources identified by the user or previously known to the model. Such resources may include compute resources (e.g., processing power) as well as other types of resources such as datasets, software packages (e.g., software, libraries, etc.), experimental resources (e.g., is there a lab available to perform the experiments and what are the features of the lab, etc.).

Experiments may be proposed for different pairs of sources and application areas in the matrix. For example, returning to FIG. 5, the model may be tasked with recommending experiments for each of the entries 512, 514, 516, 518 in the matrix 510. Alternatively, experiments may be proposed for some predefined number of different pairs of sources and application areas having the highest scores. In this regard, if the predefined number of different pairs is 2, the model may be tasked with recommending experiments for the two highest entries, here entries 516, 518. As another alternative, experiments may be proposed for all pairs of application areas and sources in the matrix having a score that meets some threshold minimum score. For example, if the threshold minimum score is 5, model may be tasked with recommending experiments for only entry 518 (as 7>5).

In some instances, the user may be provided with an option to select from one or more experiments. Whether or not an experiment has been generated for a specific application area and source pair may be indicated with or as part of the matrix (e.g., via an icon or particular visual treatment). Details of an experiment may be provided for display to the user, for example, as part of the results 610 depicted in FIG. 6. Once selected, if practical to do so using the model, the model may automatically run the experiment and provide experimental results. This may involve, for example, accessing available data sources, writing code to run the experiment (e.g., in python or another library) and/or generating a synthetic dataset automatically as needed to conduct the experiment. In some instances, the experimental results may be displayed with the results from the matrix. For example, returning to FIG. 6, the experimental results may be displayed with or within the results 610.

In some instances, the experimental results may even be used to update scores in the matrix. For example, results that tend to support the ideas represented by an application area and source pair may be used to increase a score for that pair in the matrix. Similarly, results that tend not to support an idea may be used to decrease a score for that pair in the matrix. As an example, if an application area and source pair include global supply chain and geospatial algorithms, experimental results that indicate that geospatial algorithms can be used to help improve supply chain efficiency may be used to increase a score for that pair in the matrix.

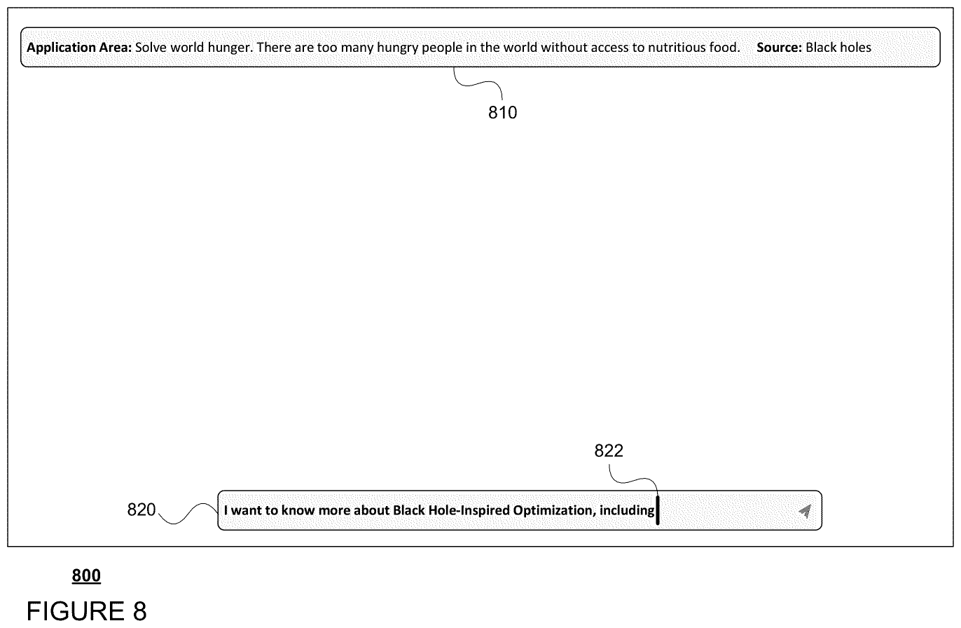

The user may also be provided with an option to share the matrix with other users to enable collaboration. For example, returning to FIG. 5, interface 500 includes option 570 to share the details of “BRAINSTORM #1”. In this regard, if selected, the user may be provided with an opportunity to select which other users with which the user would like to share a given brainstorm. For instance, the user may identify a second user with which the user wants to share the matrix and the related information. In some instances, the matrix and related information may have associated security such that the second user must log into an account associated with the system in order to access the matrix and related information. The second user may then add additional sources and applications to the brainstorm and compute the responses for shared brainstorming. In order to investigate pairs and/or ideas further, a user may select an option to chat with the model. For example, returning to FIG. 6, the results 610 are displayed with an option 630 to start a chat. If the user selects this option, the computing devices 102 may generate and display a chat interface which may provide the user with the opportunity to interact with the model about any ideas and receive responses from the model as represented in FIG. 4 at 3a). For example, FIG. 8 is an example of a chat interface 800 which may enable a user to engage in a conversation with the model about the results 610 or any other results (e.g., of any other matrix entry). As an example, interface 800 may be displayed on a client computing device, such as computing device 112, 114. In this example, information 810 provides the user with context for the chat, here identifying the use case or problem to target (“Solve world hunger. There are too many hungry people in the world without access to nutritious food.”) as well as the source (“Black holes”) for the results 610. In addition, a field 820 enables the user to enter and send text to the model in order to engage in the conversation. Here, the user is in the process of typing an instruction or further prompt to learn more information about the results as indicated by cursor 822.

The model may also be provided with an opportunity to retrieve an arbitrary snippet from another source that the user has found interesting to complement the discussion, for example, by taking prompts entered by the user and conducting a RAG search to pull additional information from those sources as represented in FIG. 4 at 3b). In some instances, the user may also be provided with an option to adjust (e.g., a slider bar, toggle switch, or other means) how distant or abstract a user wants the conversation to be with respect to other sources in the matrix.

By enabling a user to communicate with the model about an idea or pair by asking questions, the computing devices 102 may enable further innovation and refinement of the ideas.

In some instances, in addition to enabling a chat between the user and the model, this system could also launch a multi-user chat channel, for example using a chat application which allows for multiple people to engage with the model in order to augment the ideas.

The features described herein may provide a framework for identifying potential areas of innovations utilizing machine learning models such as LLMs. As described above, a user may be provided with the most relevant points of scientific papers, patents, technical reports, user needs, applications, and novel ideas as well as the possibility to chat with a foundational model about some idea, where the model draws inspiration from the complete matrix of sources and applications. The features described herein may therefore enable a user to find relevant connections across a wide range of technologies and applications areas and to explore those further regardless of the volume of source material (e.g., 50 sources, 100 sources, or more). This may potentially accelerate the pace of innovation by automating time-consuming tasks and allowing researchers, innovators and entrepreneurs to focus on the creative aspects of their work in a user-friendly, concise, and straightforward way. This, in turn, may increase the number and pace of innovations that address some of the world's most pressing challenges thus potentially providing for greater innovation at scale. Additionally, the features described herein may be used to better organize innovation information, making it accessible to others, potentially ensuring continuity in innovation efforts.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method comprising:
identifying, by one or more processors, a plurality of application areas;
identifying, by the one or more processors, a plurality of sources;
using, by the one or more processors, a model to score pairs of each one of the plurality of application areas with respect to each one the plurality of sources;
generating, by the one or more processors, a matrix of the scores; and
providing, by the one or more processors, the matrix of scores for display to a user.

2. The method of claim 1, further comprising receiving user input providing the plurality of application areas.

3. The method of claim 1, wherein each application area of the plurality of application areas defines a problem.

4. The method of claim 1, wherein each source of the plurality of sources is one of a scientific paper or article.

5. The method of claim 1, further comprising, conducting a search in order to identify at least one of the plurality of sources based on at least one of the plurality of application areas.

6. The method of claim 1, further comprising receiving user input providing the plurality of sources.

7. The method of claim 1, wherein the model is a machine learning model.

8. The method of claim 7, wherein the model is a large language model.

9. The method of claim 8, wherein the large language model is a long context model.

10. The method of claim 8, wherein the large language model is multimodal.

11. The method of claim 1, further comprising, providing information identifying the plurality of sources and the plurality of application areas for display with the matrix to enable the user to relate the scores to individual ones of the pairs.

12. The method of claim 1, wherein the matrix is generated such that different entries of the matrix with different scores are provided with different visual treatments to differentiate the different scores.

13. The method of claim 1, further comprising, providing a prompt to the model, wherein the prompt provides instructions to the model that for a given pair of one of the plurality of application areas and one of the plurality of sources to provide a summary of the source, ideas for how the one of the plurality of sources could be applied to the one of the plurality of application areas, and the score for the given pair.

14. The method of claim 1, further comprising:
receiving user input identifying a selection of an entry in the matrix; and
in response to receiving the user input, providing results of the model for display to the user.

15. The method of claim 14, wherein the entry is associated with an application area and source pair and the results include a model-generated summary of a source and ideas for how the source could be applied to an application area.

16. The method of claim 14, wherein the results are provided with an option for the user to chat with the model about the results.

17. The method of claim 16, further comprising:
receiving second user input selecting the option; and
in response to receiving the second user input, providing a chat interface to enable the user to engage in a conversation with the model about the results.

18. The method of claim 1, further comprising, providing a prompt to the model, wherein the prompt defines a rubric for determining the scores based on at least a novelty subscore and a relevance subscore for a given pair.

19. The method of claim 1, further comprising, receiving user input identifying a metric and a rubric for evaluating that metric, wherein the scores are determined further based on the received user input.

20. The method of claim 1, further comprising:
receiving at least one additional application area or source;
in response to receiving the at least one additional application area or source, updating the matrix with one or more additional scores; and
providing the updated matrix for display to the user.

21. The method of claim 1, further comprising:
generating, by the one or more processors, an experiment for at least one of the pairs; and
in response to the user selecting the experiment, running, by the one or more processors, the experiment.

22. The method of claim 21, wherein generating the experiment is based on the matrix of scores.

23. The method of claim 21, further comprising, updating the matrix of scores based on results of running the experiment.

24. A system comprising one or more processors configured to:
identify a plurality of application areas;
identify a plurality of sources;
use a model to score pairs of each one of the plurality of application areas with respect to each one the plurality of sources;
generate a matrix of the scores; and
provide the matrix of scores for display to a user.
